(19) United States
(12) Patent Application Publication
(10) Pub. No.: US 2026/0358127 A1
(43) Pub. Date: Nov. 12, 2026

(54) TRAJECTORY PREDICTION METHOD AND APPARATUS, AND STORAGE MEDIUM

(71) Applicant: Chongqing Changan Technology Co., Ltd., Chongqing (CN)

(72) Inventors: Dongfang YANG, Chongqing (CN); Jiaxuan ZHANG, Chongqing (CN); Lihong QIU, Chongqing (CN); Linhui LI, Chongqing (CN); Lecheng XIE, Chongqing (CN)

(73) Assignee: Chongqing Changan Technology Co., Ltd., Chongqing (CN)

(21) Appl. No.: 19/717,611

(22) Filed: Jun. 23, 2026

Related U.S. Application Data
(63) Continuation of application No. PCT/CN2025/124791, filed on Sep. 28, 2025.

(30) Foreign Application Priority Data
Jan. 22, 2025 (CN) 202510102803.6

(51) Int. Cl. G01C 21/28

(52) U.S. Cl. CPC G01C 21/28

(57) ABSTRACT

The present application relates to a trajectory prediction method and apparatus, and a storage medium, involving the field of automotive technologies and, in particular, to the field of automotive trajectory prediction technologies. The method is applied to a target vehicle and includes: acquiring a motion state parameter of a to-be-predicted vehicle and first candidate road points; screening the first candidate road points based on the motion state parameter and a motion feasibility constraint condition of the to-be-predicted vehicle to obtain second candidate road points; and generating a motion trajectory of the to-be-predicted vehicle based on the second candidate road points. The first candidate road points are determined based on surrounding road information of the to-be-predicted vehicle. Thus, through the present application, the technical problem of low feasibility of a predicted trajectory can be avoided.

### CROSS-REFERENCE TO RELATED APPLICATION

The present application is a continuation of International Application No. PCT/CN2025/124791, filed on Sep. 28, 2025, which claims priority to Chinese Patent Application No. 202510102803.6, entitled “Trajectory Prediction Method and Apparatus, and Storage Medium” and filed with the China National Intellectual Property Administration on Jan. 22, 2025. The disclosures of the aforementioned applications are hereby incorporated by reference in their entireties.

### TECHNICAL FIELD

The present application relates to the field of automotive technologies and, in particular, to the field of automotive trajectory prediction technologies, specifically to a trajectory prediction method and apparatus, and a storage medium.

### BACKGROUND

In recent years, widespread applications of deep neural networks in the field of trajectory prediction have indeed brought significant progress to fields such as autonomous driving and intelligent transportation. A goal-driven trajectory prediction method achieves more accurate prediction of a vehicle's future trajectory by decomposing the problem into two sub-tasks: predicting a possible goal and performing motion estimation based on contextual features. However, while pursuing a low prediction error, the method often neglects physical feasibility of a predicted trajectory.

In the related art, it is proposed to determine a predicted trajectory of a target vehicle through historical trajectory information of the target vehicle and historical trajectory information of surrounding vehicles. However, there is a problem that the predicted trajectory is determined only through the historical information, resulting in low feasibility of the predicted trajectory.

In the related art, it is proposed to predict a driving trajectory of a vehicle through a constructed attention mechanism neural network. However, there is a problem that the trajectory cannot be updated cyclically, resulting in low feasibility of the predicted trajectory.

Therefore, it is necessary to introduce more physical constraints and more complex trajectory representation methods into a prediction model to ensure that the generated predicted trajectory is both accurate and feasible.

### SUMMARY

The present application provides a trajectory prediction method and apparatus, and a storage medium, to at least solve the technical problem of low feasibility of predicted trajectories in the related art. The technical solutions of the present application are as follows.

According to a first aspect of the present application, a trajectory prediction method is provided. The method is applied to a target vehicle, and includes:
acquiring a motion state parameter of a to-be-predicted vehicle and first candidate road points; screening the first candidate road points based on the motion state parameter and a motion feasibility constraint condition of the to-be-predicted vehicle to obtain second candidate road points; and generating a motion trajectory of the to-be-predicted vehicle based on the second candidate road points;
where the first candidate road points are determined based on surrounding road information of the to-be-predicted vehicle.

It should be understood that physical feasibility is crucial in vehicle trajectory prediction because it determines whether the prediction result can be practically applied in an autonomous driving system. If the predicted trajectory violates physical feasibility, even if its average displacement error is very small, it may cause the autonomous driving vehicle to encounter a trajectory that cannot be followed during actual driving, thereby causing a safety hazard.

Based on the above technical solution, the method comprehensively considers the motion state parameter and the motion feasibility constraint condition of the vehicle, and thus the present application can obtain candidate road points that better conform to actual driving conditions of the vehicle by screening, thereby generating a more accurate driving trajectory.

At the same time, the embodiments of the present application also consider multiple factors such as the motion feasibility constraint condition (road condition, traffic rule), further improving reliability and practicality of trajectory prediction.

In some embodiments, the motion feasibility constraint condition is determined based on a road driving rule and/or configuration information of the to-be-predicted vehicle; and the motion feasibility constraint condition includes at least one of the following: a maximum acceleration constraint of the to-be-predicted vehicle, a maximum deceleration constraint of the to-be-predicted vehicle, a maximum steering constraint of the to-be-predicted vehicle, or a road speed limit constraint.

Based on the above technical solution, by comprehensively considering the above constraint conditions, the method ensures that the to-be-predicted vehicle can both deliver its optimal performance and comply with road safety regulations during motion, thereby achieving safe, efficient, and feasible vehicle motion.

In some embodiments, the acquiring the first candidate road points includes: determining a first road segment at a preset distance in a motion direction of the to-be-predicted vehicle based on position information of the to-be-predicted vehicle and the surrounding road information; discretely sampling the first road segment along a centerline of the first road segment to obtain third candidate road points; determining a first search area based on a current speed of the to-be-predicted vehicle, a heading angle of the to-be-predicted vehicle, and a road factor of the first road segment, where the road factor is determined based on a road segment type of the first road segment, a centerline orientation of the first search area is consistent with the heading angle, and a search range of the first search area is positively correlated with the current speed; and determining the first candidate road points from the third candidate road points based on the first search area.

Based on the above technical solution, the method achieves dynamic and accurate determination of the first search area by comprehensively considering the current speed and the heading angle of the to-be-predicted vehicle and road factors under different scenarios, thereby facilitating improvement of safety of vehicle driving and prediction accuracy.

In some embodiments, the screening the first candidate road points based on the motion state parameter and the motion feasibility constraint condition of the to-be-predicted vehicle to obtain the second candidate road points includes: removing candidate points located within a near-end deceleration range and candidate points located outside a far-end acceleration range from the first candidate road points by screening to obtain the second candidate road points; where the near-end deceleration range is determined based on the current speed and the maximum deceleration constraint of the to-be-predicted vehicle, and the far-end acceleration range is determined based on the current speed, the maximum acceleration constraint, and the road speed limit constraint of the to-be-predicted vehicle.

Based on the above technical solution, through the above screening mechanism, the method can effectively eliminate, one by one, candidate road points of the to-be-predicted vehicle that are theoretically unreachable within the prediction time range or infeasible for actual driving, thereby ensuring precision and practicality of a prediction result, and further optimizing accuracy and reliability of vehicle trajectory prediction.

In some embodiments, the generating the motion trajectory of the to-be-predicted vehicle based on the second candidate road points includes: determining a target road point from the second candidate road points; and generating the motion trajectory of the to-be-predicted vehicle based on the target road point; where the motion trajectory is a trajectory between a current position of the to-be-predicted vehicle and the target road point.

Based on the above technical solution, by determining the target road point from the second candidate road points and generating the motion trajectory based on this point, the embodiments of the present application can more accurately predict a future driving path of the vehicle, reduce a prediction error, and further improve the reliability and practicality of the trajectory prediction.

In some embodiments, the determining the target road point from the second candidate road points includes: inputting position information of the to-be-predicted vehicle, the motion state parameter of the to-be-predicted vehicle, and position information of the second candidate road points into a graph attention network model to obtain a target road point with a highest attention coefficient among the second candidate road points; where the attention coefficient is used to characterize a confidence degree of the to-be-predicted vehicle with respect to a candidate road point.

Based on the above technical solution, by introducing the graph attention network model in the method, the embodiments of the present application can more accurately capture a relationship between the vehicle and road points, as well as a potential impact of different road points on a driving path of the vehicle. In addition, the attention mechanism enables the model to adaptively focus on the candidate road point that has the greatest impact on the driving path of the vehicle, thereby improving accuracy and robustness of the trajectory prediction.

In some embodiments, the generating the motion trajectory of the to-be-predicted vehicle based on the target road point includes: determining a reference path for the to-be-predicted vehicle based on the target road point, where the reference path is an expected path between a lane segment where the to-be-predicted vehicle is located and a lane segment where the target road point is located; determining a plurality of driving coordinates of the to-be-predicted vehicle based on the reference path and position information of the to-be-predicted vehicle; and generating the motion trajectory of the to-be-predicted vehicle according to the plurality of driving coordinates, where the motion trajectory is a trajectory between the current position of the to-be-predicted vehicle and the target road point.

Based on the above technical solution, the method comprehensively considers the position information and the motion state of the to-be-predicted vehicle and the position information of the target road point, and thus the embodiments of the present application can generate the reference path and the motion trajectory that better conform to the actual driving conditions of the vehicle.

In addition, the determination of driving coordinates and the generation process of the motion trajectory fully consider dynamic characteristics of the vehicle and road conditions, further improving the accuracy and reliability of the trajectory prediction.

In some embodiments, the reference path includes a plurality of preview points, and the preview points are used to characterize expected coordinates on the reference path. The determining the plurality of driving coordinates of the to-be-predicted vehicle based on the reference path and the position information of the to-be-predicted vehicle includes: for each preview point of the plurality of preview points, determining, based on the motion state parameter of the to-be-predicted vehicle, a steering angle required for the to-be-predicted vehicle to drive to the preview point; determining an acceleration of the to-be-predicted vehicle based on the position information of the to-be-predicted vehicle and the target road point; and determining driving coordinates of the to-be-predicted vehicle based on the acceleration and the steering angle, to obtain driving coordinates of the to-be-predicted vehicle corresponding to the plurality of preview points.

Based on the above technical solution, the method continuously updates positions of the preview points and repeatedly performs the pure pursuit algorithm calculation and steering angle adjustment process described above. Through continuous iteration and optimization, the to-be-predicted vehicle can gradually approach and stably maintain driving on the reference path, thereby generating a plurality of driving coordinates of the to-be-predicted vehicle.

In some embodiments, the determining the reference path for the to-be-predicted vehicle based on the target road point includes: acquiring a set of lane segments between a target lane segment and the lane segment where the to-be-predicted vehicle is located, where the target lane segment is the lane segment where the target road point is located; and equidistantly sampling each lane segment in the set of lane segments along a lane centerline, to generate the reference path between the target lane segment and the lane segment where the to-be-predicted vehicle is located.

Based on the above technical solution, in the method, the set of lane segments between the target lane segment and the lane segment where the to-be-predicted vehicle is located is acquired, and equidistant sampling is performed along the lane centerline. Thus, the embodiments of the present application can generate a reference path that better conforms to the actual driving conditions of the vehicle, and the accuracy and the reliability of the reference path are significantly improved, providing strong support for autonomous driving and path planning of the vehicle.

According to a second aspect of the present application, a trajectory prediction apparatus is provided. The apparatus includes: a processing unit and an acquiring unit. The acquiring unit is configured to acquire a motion state parameter of a to-be-predicted vehicle and first candidate road points, where the first candidate road points are determined based on surrounding road information of the to-be-predicted vehicle. The processing unit is configured to screen the first candidate road points based on the motion state parameter and a motion feasibility constraint condition of the to-be-predicted vehicle to obtain second candidate road points. The processing unit is further configured to generate a motion trajectory of the to-be-predicted vehicle based on the second candidate road points.

According to a third aspect of the present application, a vehicle is provided, and includes the trajectory prediction apparatus according to the second aspect.

According to a fourth aspect of the present application, an electronic device is provided, and includes: a processor; and a memory, configured to store instructions executable by the processor; where the processor is configured to execute the instructions to implement the method according to the first aspect and any possible implementation thereof.

According to a fifth aspect of the present application, a computer-readable storage medium is provided. When instructions in the computer-readable storage medium are executed by a processor of an electronic device, the electronic device is enabled to perform the method according to the first aspect and any possible implementation thereof.

According to a sixth aspect of the present application, a computer program product is provided. The computer program product includes computer instructions, and when the computer instructions are executed on an electronic device, the electronic device is caused to perform the method according to the first aspect and any possible implementation thereof.

In view of above, the above technical features of the present application have the following beneficial effects.
(1) In the embodiments of the present application, by comprehensively considering the motion state parameter and the motion feasibility constraint condition of the vehicle, the present application can obtain candidate road points that better conform to the actual driving conditions of the vehicle by screening, thereby generating the more accurate driving trajectory.

At the same time, the embodiments of the present application also consider multiple factors such as the motion feasibility constraint condition (road condition, traffic rule), further improving the reliability and the practicality of the trajectory prediction.
(2) By comprehensively considering the above constraint conditions, the embodiments of the present application ensure that the to-be-predicted vehicle can both deliver its optimal performance and comply with the road safety regulations during the motion, thereby achieving the safe, efficient, and feasible vehicle motion.
(3) By comprehensively considering the current speed and the heading angle of the to-be-predicted vehicle and the road factors under different scenarios, the embodiments of the present application achieve the dynamic and accurate determination of the first search area, thereby facilitating improvement of the safety of the vehicle driving and the prediction accuracy.
(4) Through the above screening mechanism, the embodiments of the present application can effectively eliminate, one by one, the candidate road points of the to-be-predicted vehicle that are theoretically unreachable within the prediction time range or infeasible for actual driving, thereby ensuring the precision and practicality of the prediction result, and further optimizing the accuracy and reliability of the vehicle trajectory prediction.
(5) By determining the target road point from the second candidate road points and generating the motion trajectory based on this point in the embodiments of the present application, the embodiments of the present application can more accurately predict the future driving path of the vehicle, reduce the prediction error, and further improve the reliability and practicality of the trajectory prediction.
(6) By introducing the graph attention network model in the embodiments of the present application, the embodiments of the present application can more accurately capture the relationship between the vehicle and the road points, as well as the potential impact of different road points on the driving path of the vehicle. In addition, the attention mechanism enables the model to adaptively focus on the candidate road point that has the greatest impact on the driving path of the vehicle, thereby improving the accuracy and robustness of the trajectory prediction.
(7) By comprehensively considering the position information and the motion state of the to-be-predicted vehicle and the position information of the target road point in the embodiments of the present application, the embodiments of the present application can generate the reference path and the motion trajectory that better conform to the actual driving conditions of the vehicle.

In addition, the determination of driving coordinates and the generation process of the motion trajectory fully consider the dynamic characteristics of the vehicle and the road conditions, further improving the accuracy and reliability of the trajectory prediction.
(8) In the embodiments of the present application, the positions of the preview points are continuously updated, and the pure pursuit algorithm calculation and the steering angle adjustment process described above are repeatedly performed. Through continuous iteration and optimization, the to-be-predicted vehicle can gradually approach and stably maintain driving on the reference path, thereby generating a plurality of driving coordinates of the to-be-predicted vehicle.
(9) In the embodiments of the present application, the set of lane segments between the target lane segment and the lane segment where the to-be-predicted vehicle is located is acquired, and equidistant sampling is performed along the lane centerline. Thus, the embodiments of the present application can generate the reference path that better conforms to the actual driving conditions of the vehicle, and the accuracy and the reliability of the reference path are significantly improved, providing the strong support for the autonomous driving and path planning of the vehicle.

It should be noted that for the technical effects brought about by any implementation of the second aspect to the sixth aspect, reference can be made to the technical effects brought about by the corresponding implementation of the first aspect, which will not be repeated here.

It should be understood that the above general description and the following detailed description are merely exemplary and explanatory, and are not used to limit the present application.

### BRIEF DESCRIPTION OF DRAWINGS

The accompanying drawings here, incorporated into the specification and constituting a part of the specification, show embodiments that comply with the present application. They are used to explain the principle of the present application together with the specification, and do not constitute an undue limitation on the present application.

FIG. 1 is a schematic structural diagram of a vehicle according to an exemplary embodiment.

FIG. 2 is a block diagram of a trajectory prediction apparatus according to an exemplary embodiment.

FIG. 3 is a schematic flowchart of a trajectory prediction method according to an exemplary embodiment.

FIG. 4 is a scenario diagram of a trajectory prediction method according to an exemplary embodiment.

FIG. 5 is a scenario diagram of another trajectory prediction method according to an exemplary embodiment.

FIG. 6 is a diagram of a geometric relationship of a preview point according to an exemplary embodiment.

FIG. 7 is a block diagram of another trajectory prediction apparatus according to an exemplary embodiment.

FIG. 8 is a block diagram of an electronic device according to an exemplary embodiment.

### DESCRIPTION OF EMBODIMENTS

In order to enable those of ordinary skill in the art to better understand the technical solutions of the present application, the technical solutions in the embodiments of the present application will be clearly and completely described below with reference to the accompanying drawings.

It should be noted that the terms such as “first” and “second” in the description and claims of the present application as well as in the above drawings are used to distinguish similar objects, and are not necessarily used to describe a specific order or sequence. It should be understood that terms used in this way may be interchanged under appropriate circumstances, so that the embodiments of the present application described herein can be implemented in an order other than those illustrated or described herein. The implementations described in the following exemplary embodiments do not represent all implementations consistent with the present application. On the contrary, they are merely examples of apparatuses and methods consistent with some aspects of the present application as detailed in the appended claims.

In the embodiments of the present application, words such as “exemplary”, “such as”, or “for example” are used to represent an example, illustration, or explanation. Any embodiment or design solution described as “exemplary”, “such as”, or “for example” in the embodiments of the present application should not be interpreted as being more preferred or advantageous than other embodiments or design solutions. To be precise, the use of words such as “exemplary”, “such as”, or “for example” is intended to present related concepts in a specific manner.

First, relevant technologies involved in the present application are explained to facilitate understanding by those skilled in the art.

In recent years, widespread applications of deep neural networks in the field of trajectory prediction have indeed brought significant progress to fields such as autonomous driving and intelligent transportation. Goal-driven trajectory prediction methods achieve more accurate prediction of a vehicle's future trajectory by decomposing the problem into two sub-tasks: predicting a possible goal and performing motion estimation based on contextual features. However, while pursuing a low prediction error, these methods often neglects physical feasibility of a predicted trajectory, which is an issue worth in-depth discussion.

In order to solve the above problem, for the goal, a more complex trajectory representation method may be adopted to more comprehensively describe the occupancy of the vehicle in space, and then the predicted trajectory of the vehicle is generate, thereby overcoming the problem of low feasibility. This method can more accurately reflect actual occupied space of the vehicle, thereby improving the physical feasibility of a prediction result.

In summary, although deep learning-based trajectory prediction methods have achieved remarkable results in reducing prediction error, physical feasibility remains one of the key factors restricting their practical application. In the future, researchers need to introduce more physical constraints and more complex trajectory representation methods into a prediction model to ensure that the generated prediction trajectory is both accurate and feasible. This will provide a more reliable guarantee for the practical application of intelligent transportation systems such as autonomous driving.

The technical solutions in the embodiments of the present application will be described below with reference to the accompanying drawings in the embodiments of the present application. Obviously, the described embodiments are part of the embodiments of the present application, not all embodiments.

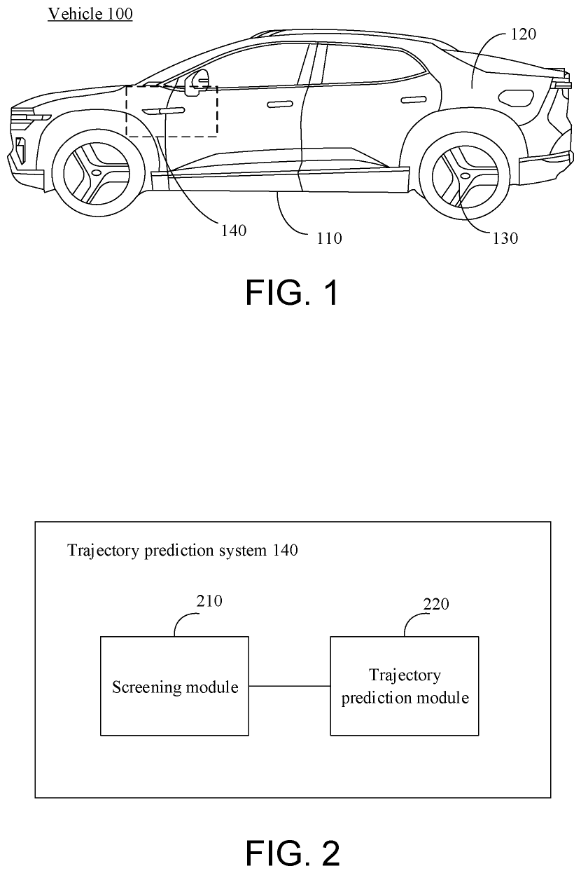

The trajectory prediction methods provided by the embodiments of the present application may be applied in a vehicle. As shown in FIG. 1, a schematic structural diagram of a vehicle provided by an embodiment of the present application is shown. The vehicle 100 may include a chassis 110, a vehicle body 120, and wheels 130. It can be understood that the vehicle 100 may be a fuel vehicle, an electric vehicle, a hybrid electric vehicle, a gas vehicle, a methanol vehicle, a solar vehicle, etc.

Exemplarily, the vehicle 100 may be a passenger car such as a sedan, a sport utility vehicle (SUV), a multi-purpose vehicle (MPV), etc., or may be a bus, a truck, a semi-trailer, etc. The present application does not specifically limit this.

It can be understood that the above components are merely examples of some components of the vehicle 100 and are not limitations on the specific structure of the vehicle 100.

In an embodiment, in order to control the vehicle, the vehicle 100 may further include a trajectory prediction system 140. The trajectory prediction system 140 can achieve prediction on a motion trajectory of a to-be-predicted vehicle around the vehicle 100.

As shown in FIG. 2, an embodiment of the present application provides a block diagram of a trajectory prediction system 140. The trajectory prediction system 140 includes a screening module 210 and a trajectory prediction module 220.

The screening module 210 is configured to screen first candidate road points in accordance with a motion feasibility constraint condition of the to-be-predicted vehicle and an acquired motion state parameter of the to-be-predicted vehicle to obtain second candidate road points, and send the second candidate road points to the trajectory prediction module 220.

The trajectory prediction module 220 is configured to generate a motion trajectory of the to-be-predicted vehicle according to the second candidate road points.

It should be noted that the trajectory prediction system described in the embodiments of the present application is intended to illustrate the technical solutions of the embodiments of the present application more clearly and does not constitute a limitation on the technical solutions provided by the embodiments of the present application. Those of ordinary skill in the art will appreciate that with the evolution of an electronic device and the emergence of other electronic devices, the technical solutions provided by the embodiments of the present application are also applicable to similar technical problems. The methods in the following embodiments may all be implemented in a trajectory prediction system having the above hardware structure.

A trajectory prediction method provided by the embodiments of the present application is described in detail below with reference to the accompanying drawings.

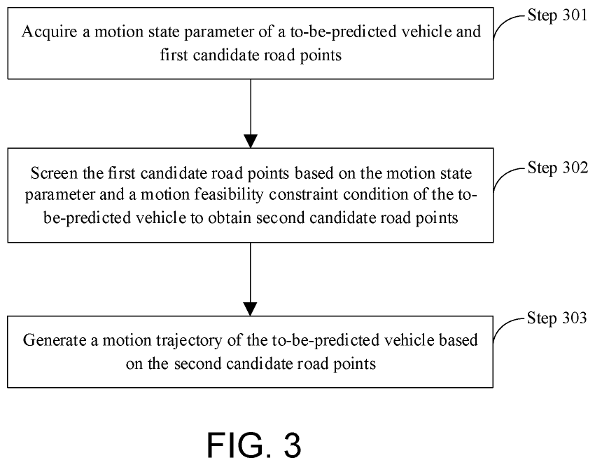

A trajectory prediction method of the embodiments of the present application may be applied to predict a motion trajectory of a to-be-predicted vehicle. As shown in FIG. 3, the trajectory prediction method may include step 301 to step 303. The step 301 may also be referred to as a process of “acquiring a motion state parameter of a to-be-predicted vehicle and first candidate road points”, and step 302 to step 303 may be referred to as a process of “generating a motion trajectory of the to-be-predicted vehicle”. The step 301 to step 303 are described in detail below.

Step 301, acquire a motion state parameter of a to-be-predicted vehicle and first candidate road points.

In related embodiments of the present application, the first candidate road points are determined based on surrounding road information of the to-be-predicted vehicle, and the motion state parameter includes, but is not limited to, a current speed, an acceleration, a position, a heading angle and/or the like of the to-be-predicted vehicle.

Exemplarily, a trajectory prediction system may acquire, through onboard perception sensors and a positioning system of a target vehicle, motion state parameters

$${S}_{i}^{t} = \{ {p}_{i}^{t} , {v}_{i}^{t} , {a}_{i}^{t} , {θ}_{i}^{t} \}$$

of all to-be-predicted vehicles in a scene where the target vehicle is located, and acquire road information surrounding the to-be-predicted vehicles through a high-precision map. The surrounding road information includes, but is not limited to, lane point positions and a lane adjacency relationship. Then, the first candidate road points, i.e., initial candidate road points, are determined through the surrounding road information.

Here, i=0, 1, 2, . . . represents a vehicle number, where i=0 represents the target vehicle, i=1, 2, 3 . . . represents to-be-predicted vehicles surrounding the target vehicle; t=−T, −T+1, . . . , 0 represents a time step, where t=0 is a current moment, represents

$${p}_{i}^{t}$$

represents position information of an i-th to-be-predicted vehicle at moment t;

$${v}_{i}^{t}$$

represents speed information of the i-th to-be-predicted vehicle at moment t;

$${a}_{i}^{t}$$

represents acceleration information of the i-th to-be-predicted vehicle at moment t;

$${θ}_{i}^{t}$$

represents heading angle information of the i-th to-be-predicted vehicle at moment t.

In some embodiments, the trajectory prediction system may determine a first road segment at a preset distance in a motion direction of the to-be-predicted vehicle based on position information of the to-be-predicted vehicle and the surrounding road information, and discretely sample the first road segment along a centerline of the first road segment to obtain third candidate road points. Then, the trajectory prediction system may determine a first search area based on a current speed of the to-be-predicted vehicle, a heading angle of the to-be-predicted vehicle, and a road factor of the first road segment, and determine the first candidate road points from the third candidate road points based on the first search area.

The road factor is determined based on a road segment type of the first road segment and is used to characterize a degree of freedom of the to-be-predicted vehicle in the scene; a centerline orientation of the first search area is consistent with the heading angle; and a search range of the first search area is positively correlated with the current speed.

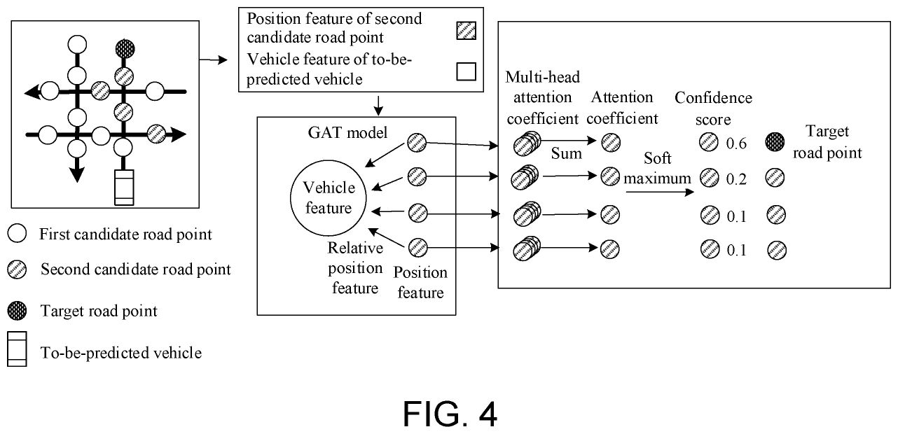

Exemplarily, the trajectory prediction system performs uniform discrete sampling on the first road segment along the centerline of the first road segment at a sampling interval of 3M to obtain the third candidate road points. The first search area Rᵢ may be determined by the following Formula 1, and candidate road points located within the range of the first search area Rᵢ are obtained as the first candidate road points (for example, the first candidate road points shown in FIG. 4), by screening with the current position of the to-be-predicted vehicle as a center of a circle.

$${R}_{i} = {av}_{i}^{0} + {R}_{0} \qquad Formula 1$$

where,

$${v}_{i}^{0}$$

represents the current speed of the to-be-predicted vehicle, R₀ represents a range threshold (to prevent the search range from being too small due to an excessively low vehicle speed), and a represents the road factor (taking a different value depending on a scene type: a larger value for an non-intersection scene and a smaller value for an intersection scene). For example, for the to-be-predicted vehicle in the non-intersection scene, a relatively large value may be assigned to the road factor to reflect relative degree of freedom and a larger safety space of the vehicle driving in the non-intersection scene; in the intersection scene, a relatively small value is assigned to the road factor to reflect a limitation and a higher safety requirement of vehicle driving in the intersection scene.

In addition, the first search area may be a semicircular search area, and an orientation of an angle bisector of the first search area is the same as a direction of a current heading angle θ₀⁰ of the to-be-predicted vehicle.

It should be understood that by comprehensively considering the vehicle speed and road factors under different scenes, the embodiments of the present application achieve dynamic and accurate determination of the first search area, thereby facilitating improvement of driving safety and prediction accuracy for the to-be-predicted vehicle.

Step 302, screen the first candidate road points based on the motion state parameter and a motion feasibility constraint condition of the to-be-predicted vehicle to obtain second candidate road points.

In related embodiments of the present application, the motion feasibility constraint condition is determined based on a road driving rule and/or configuration information of the to-be-predicted vehicle, and the motion feasibility constraint condition includes, but is not limited to, a maximum acceleration constraint of the to-be-predicted vehicle, a maximum deceleration constraint of the to-be-predicted vehicle, or a road speed limit constraint.

In some embodiments, the trajectory prediction system may remove candidate points located within a near-end deceleration range and candidate points located outside a far-end acceleration range from the first candidate road points by screening to obtain the second candidate road points.

The near-end deceleration range is determined based on the current speed and the maximum deceleration constraint of the to-be-predicted vehicle, and the far-end acceleration range is determined based on the current speed, the maximum acceleration constraint, and the road speed limit constraint of the to-be-predicted vehicle.

Exemplarily, the trajectory prediction system may determine a distance that the to-be-predicted vehicle drives while decelerating within a preset time period based on the current speed of the to-be-predicted vehicle and a maximum deceleration of the to-be-predicted vehicle, and then use the deceleration driving distance as the near-end deceleration range, and remove the candidate points located within the near-end deceleration range from the first candidate road points by screening.

The trajectory prediction system may also determine a distance that the to-be-predicted vehicle drives while accelerating within a preset time period based on the current speed of the to-be-predicted vehicle, a maximum acceleration of the to-be-predicted vehicle, and the road speed limit constraint, and then use the acceleration driving distance as the far-end acceleration range, and remove the candidate points located outside the far-end acceleration range from the first candidate road points by screening. In this way, the trajectory prediction system uses candidate points remaining after the near-end deceleration range screening and the far-end acceleration range screening as the second candidate road points, for example, the second candidate road points shown in FIG. 4.

It should be understood that when the maximum acceleration of the to-be-predicted vehicle within the preset time period reaches the road speed limit constraint, the to-be-predicted vehicle drives at the road speed limit constraint. Through the above screening mechanism, the embodiments of the present application can effectively eliminate, one by one, candidate road points of the to-be-predicted vehicle that are theoretically unreachable within the prediction time range or infeasible for actual driving, thereby ensuring precision and practicality of a prediction result, and further optimizing accuracy and reliability of vehicle trajectory prediction.

Step 303, generate a motion trajectory of the to-be-predicted vehicle based on the second candidate road points.

In the embodiment of the present application, the trajectory prediction system may determine a target road point from the second candidate road points, and generate the motion trajectory of the to-be-predicted vehicle based on the target road point.

The motion trajectory is a trajectory between the current position of the to-be-predicted vehicle and the target road point.

In some embodiments, the trajectory prediction system inputs the position information of the to-be-predicted vehicle, the motion state parameter of the to-be-predicted vehicle, and position information of the second candidate road points into a graph attention network model to obtain a target road point with a highest attention coefficient among the second candidate road points.

The attention coefficient is used to characterize a confidence degree of the to-be-predicted vehicle with respect to the candidate road point.

Exemplarily, as shown in FIG. 4, the trajectory prediction system may encode the motion state parameter and the position information of the to-be-predicted vehicle by using a Transformer module of a cross-attention mechanism to obtain a vehicle feature of the to-be-predicted vehicle. The vehicle feature includes, but is not limited to, a current speed, an acceleration, a position, a heading angle and/or the like of the to-be-predicted vehicle.

Further, the trajectory prediction system may determine a relative position vector r_{i,j} between a position feature of a second candidate road point and the to-be-predicted vehicle, i.e., to obtain a distance between the position of the second candidate road point and the position of the to-be-predicted vehicle. For example,

$${r}_{i , j} = {p}_{j} - {p}_{i}^{0} , where {p}_{i}^{0}$$

represents the position information of the i-th to-be-predicted vehicle in a current moment, and pⱼ represents the position information of the j-th second candidate road point.

The trajectory prediction system encodes the position information p; of the j-th second candidate road point and the relative position vector r_{i,j} between the second candidate point and the to-be-predicted vehicle through a multilayer perceptron to obtain a relative position feature between the position feature Fⱼ of the j-th second candidate point and the to-be-predicted vehicle.

$${F}_{i} = Transformer ( {S}_{i}^{t = - T , - T + 1 , … , 0} )$$

$${F}_{j} = MLP ( {p}_{j} ) , {E}_{i , j} = MLP ( {r}_{i , j} )$$

where, Transformer(⋅) is a Transformer encoding module for encoding vehicle temporal information,

$${S}_{i}^{t = - T , - T + 1 , … , 0}$$

is the motion state parameter of the to-be-predicted vehicle, r_{i,j} is the relative position vector between the surrounding candidate point and the to-be-predicted vehicle, MLP(⋅) is the multilayer perceptron, and E_{i,j} represents the relative position feature between the second candidate point and the to-be-predicted vehicle.

Further, by using the above vehicle feature Fᵢ as a vehicle node attribute, the position feature Fⱼ of the j-th second candidate point as a candidate point node attribute, and the relative position feature E_{i,j} as a directed edge attribute, a graph structure may be constructed according to a plurality of attributes.

Specifically, in the embodiments of the present application, construction of the above graph structure may use the to-be-predicted vehicle as a starting node, and meanwhile a plurality of second candidate road points are introduced as other nodes. On this basis, a directed edge E_{i,j} is defined, and each directed edge E_{i,j} starts from the to-be-predicted vehicle and points to a corresponding second candidate road point.

Next, to improve an information expression capability of the graph structure, corresponding attributes may be assigned to the above nodes and edges. Specifically, the attribute of the to-be-predicted vehicle is set based on its self-encoded vehicle feature Fᵢ, and a value of the attribute of the j-th second candidate point is assigned based on its encoded position feature Fⱼ. For the directed edge, the relative position feature E_{i,j} is used as its attribute.

To facilitate subsequent graph data processing and analysis, in the embodiments of the present application, graph data conforming to a specific format is further constructed. A dimension of a node feature matrix is set to (N_nodes, feature_dim), and a value of N_nodes is 1 (representing the vehicle node)+N (representing the total number of candidate point nodes). In terms of edge representation, the embodiments of the present application use a form of an edge list or an adjacency matrix for description. In view of the advantages of GAT (graph attention network) in processing the graph data, the embodiments of the present application tend to use the edge list to explicitly specify neighbor nodes for each node. Specifically, in the embodiments, the neighbor nodes of vehicle node i are all candidate point nodes j. In addition, in the embodiments of the present application, an edge feature matrix is further constructed with a dimension of (N_edges, edge_feature_dim), where a value of N_edges is N, because there is one directed edge from the vehicle node to each second candidate point node.

Further, the trajectory prediction system may input the constructed graph data into a graph attention network (graph attention network, GAT) model. The GAT model may compute multi-head attention coefficients of the to-be-predicted vehicle with respect to the second candidate road points according to the graph data (node attributes and edge attributes), sum the multi-head attention coefficients of each second candidate road point to determine an attention coefficient of the each second candidate road point, and select a candidate road point with a highest attention coefficient among the plurality of second candidate road point as the target road point.

It should be understood that the attention coefficient may also be used to characterize an attention degree of the to-be-predicted vehicle to the second candidate road point. A larger attention coefficient represents a closer and more important relationship between the to-be-predicted vehicle and the corresponding candidate point. This helps the model to pay more attention to candidate road points that have a significant impact on the prediction result in subsequent processing.

Furthermore, the trajectory prediction system may further perform a soft maximum calculation on the attention coefficients to obtain normalized attention coefficients, i.e., confidence scores for the second candidate road points, and select a second candidate road point with a highest confidence score as the target road point.

The confidence score may be used to characterize a trust degree of the to-be-predicted vehicle to each candidate road point.

For example, the attention coefficient may be obtained by the following Formula 2.

αⱼ=GAT(Fᵢ,Fⱼ,E_{i,j}) Formula 2
where, GAT(⋅) is the graph attention network, and αⱼ is the attention coefficient.

The normalized attention coefficient may be obtained by the following Formula 3.

$${α}_{j}^{′} = Softmax ( {α}_{j} ) \qquad Formula 3$$

where, Softmax(⋅) is a softmax function for calculating the soft maximum, and

$${α}_{j}^{′}$$

is the normalized attention coefficient.

In some embodiments, the trajectory prediction system may determine a reference path for the to-be-predicted vehicle based on the target road point, then determine a plurality of driving coordinates of the to-be-predicted vehicle based on the reference path and the position information of the to-be-predicted vehicle, and generate the motion trajectory of the to-be-predicted vehicle according to the plurality of driving coordinates.

The reference path is an expected path between a lane segment where the to-be-predicted vehicle is located and a lane segment where the target road point is located, and the motion trajectory is a trajectory between the current position of the to-be-predicted vehicle and the target road point.

Exemplarily, the trajectory prediction system may acquire a set of lane segments between a target lane segment and the lane segment where the to-be-predicted vehicle is located, and equidistantly sample each lane segment in the set of lane segments along a lane centerline, to generate the reference path between the target lane segment and the lane segment where the to-be-predicted vehicle is located.

The target lane segment is the lane segment where the target road point is located.

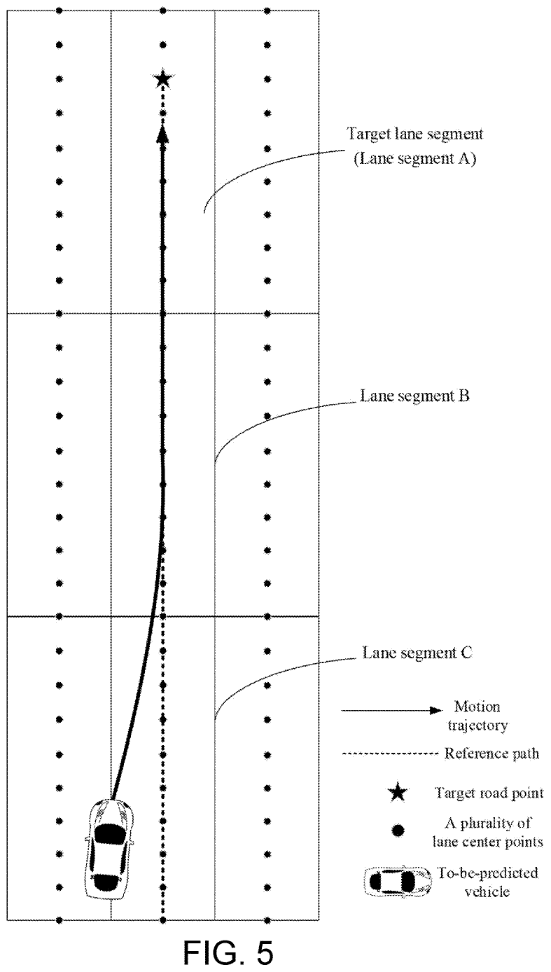

In a scenario, as shown in FIG. 5, starting from the target lane segment (lane segment A), a search traversal is performed on its longitudinal rearward lane segments and lateral adjacent lane segments until the lane segment where the to-be-predicted vehicle is located is found, thereby obtaining the set of lane segments between the target lane segment and the lane segment where the to-be-predicted vehicle is located, such as lane segment A, lane segment B, and lane segment C.

Further, equidistant sampling is performed on each lane segment in the set of lane segments along the lane centerline to obtain a plurality of lane center points, and the plurality of lane center points are connected to generate the reference path.

In some embodiments, for each preview point of a plurality of preview points, the trajectory prediction system determines driving coordinates of the to-be-predicted vehicle based on the preview point and the position information of the to-be-predicted vehicle, to obtain the plurality of driving coordinates of the to-be-predicted vehicle.

The reference path includes the plurality of preview points, and the preview points are used to characterize expected coordinates on the reference path.

Exemplarily, the trajectory prediction system may determine, based on the motion state parameter of the to-be-predicted vehicle, a steering angle required for the to-be-predicted vehicle to drive to the preview point, then determine an acceleration of the to-be-predicted vehicle based on the position information of the to-be-predicted vehicle and the target road point, and determine driving coordinates of the to-be-predicted vehicle based on the acceleration and the steering angle, to obtain driving coordinates of the to-be-predicted vehicle corresponding to the plurality of preview points.

In a scenario, the trajectory prediction system may determine one or more preview points as short-term goals according to the position information of the to-be-predicted vehicle and the reference path. Subsequently, the trajectory prediction system may calculate and determine the steering angle (front wheel angle adjustment) of the to-be-predicted vehicle by using a pure pursuit algorithm, then control the to-be-predicted vehicle to track the preview points on the reference path in accordance with the steering angle, and update the current motion state parameter (such as speed, acceleration, etc.) of the to-be-predicted vehicle and path geometric features. Next, the trajectory prediction system may send a calculated front wheel angle command to a vehicle steering system to execute a steering operation. After the vehicle executes the steering, its state (position, speed, direction, etc.) is updated accordingly. This process is repeated continuously within a preset prediction time period. In each iteration, the preview point(s) is (are) re-determined and the front wheel angle is recalculated based on the latest vehicle state and reference path information, so as to achieve continuous and precise tracking of the reference path, ultimately generating a smooth vehicle motion trajectory that meets path requirements.

It should be understood that the preview points are typically located at a certain distance ahead of the to-be-predicted vehicle, and their selection needs to consider factors such as the driving speed of the to-be-predicted vehicle, a path curvature, and a system response time, to ensure that the to-be-predicted vehicle can adjust a driving direction promptly and smoothly.

Specifically, the trajectory prediction system uses the position of the to-be-predicted vehicle as a starting point, and previews forward along the reference path at a preset look-ahead distance to obtain the preview point. The preset look-ahead distance

$${L}_{{f}_{i}}^{t}$$

may be determined by the following Formula 4.

$${L}_{{f}_{i}}^{t} = α {v}_{i}^{t} + {β ( {a}_{i}^{t} )}^{3} + {L}_{fc} \qquad Formula 4$$

where,

$${v}_{i}^{t}$$

represents a speed of the i-th to-be-predicted vehicle at moment t;

$${a}_{i}^{t}$$

represents an acceleration of the i-th to-be-predicted vehicle at moment t; α and β represent constant coefficients, which may be adjusted according to a vehicle type and a road condition; L_{fc} represents a distance threshold, which is used to prevent a look-ahead distance from being too small when the to-be-predicted vehicle is driving at a low speed.

Further, the trajectory prediction system calculates and determines the steering angle according to the position information of the to-be-predicted vehicle and the position information of the preview point, and then controls the to-be-predicted vehicle to track the preview point on the reference path in accordance with the steering angle, so as to update a pose of the to-be-predicted vehicle. The steering angle δ_{f} (lateral control variable) may be determined by the following Formula 5.

$${δ}_{f} = {tan}^{- 1} ( \frac{2 L sin ( {α}^{t} )}{{L}_{{f}_{i}}^{t}} ) \qquad Formula 5$$

$$where , \{ \begin{matrix}{δ}_{0} , & {δ}_{f} > {δ}_{0} \\ {δ}_{i}^{t} , & - {δ}_{0} < {δ}_{f} < {δ}_{0} \\ - {δ}_{0} , & {δ}_{f} < - {δ}_{0}\end{matrix} .$$

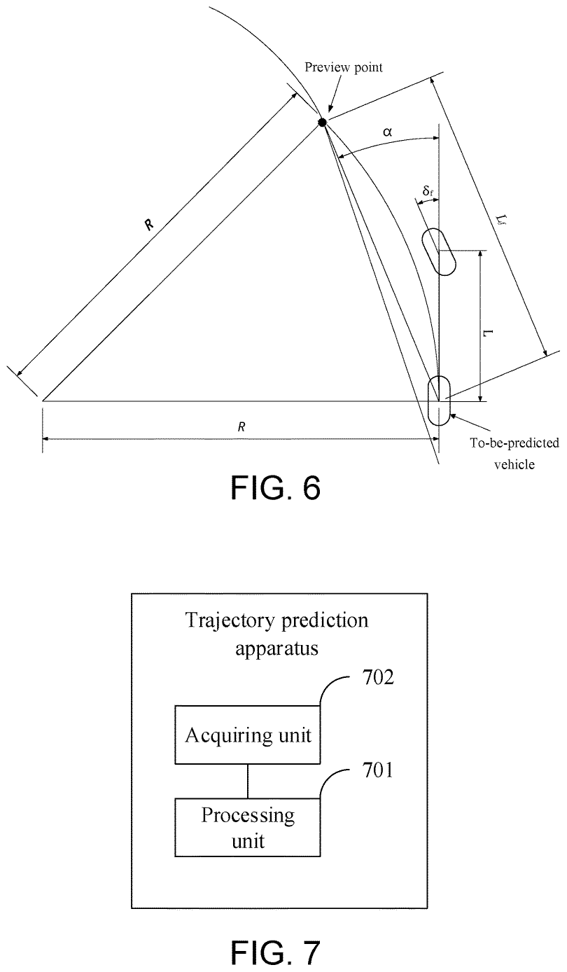

A geometric relationship between the preview point and the to-be-predicted vehicle is shown in FIG. 6, where L represents a wheelbase of the to-be-predicted vehicle, α is an angle between the to-be-predicted vehicle and the preview point, L_{f} represents a distance between the to-be-predicted vehicle and the preview point, δ_{f} represents the steering angle, R represents a radius, α^{t} represents an angle between the to-be-predicted vehicle and the preview point at moment t,

$${L}_{{f}_{i}}^{t}$$

represents a distance between the to-be-predicted vehicle and the preview point at moment t, δ₀ represents a preset maximum steering angle, and −δ₀ represents a preset minimum steering angle.

It should be understood that if the calculated steering angle is greater than the preset maximum steering angle, a maximum steering constraint (i.e., the preset maximum steering angle) in the motion feasibility constraint condition cannot be satisfied, therefore, the preset maximum steering angle is used as a current steering angle of the to-be-predicted vehicle; if the calculated steering angle is less than the preset minimum steering angle, the preset minimum steering angle is used as the current steering angle of the to-be-predicted vehicle.

Further, the distance dᵢ between the to-be-predicted vehicle and the target road point is determined. The acceleration a_{i,c} of the to-be-predicted vehicle within the prediction time period is calculated according to the prediction time period, the speed of the to-be-predicted vehicle, and the distance dᵢ. The acceleration a_{i,c} serves as another control variable (longitudinal control variable) for controlling vehicle motion.

$${d}_{i} = \sqrt{{( {g}_{i , x} - {p}_{i , x}^{0} )}^{2} + {( {g}_{i , y} - {p}_{i , y}^{0} )}^{2}} \qquad Formula 6$$

$${a}_{i , c} = \frac{2 ( {d}_{i} - {v}_{i}^{0} T ′ )}{T {′}^{2}} \qquad Formula 7$$

where,

$${p}_{i}^{0}$$

represents the position information of the i-th to-be-predicted vehicle, (g_{i,x},g_{i,y}) represents the position coordinates of the target road point,

$$( {x}_{i}^{0} , {y}_{i}^{0} )$$

represents coordinates of the position information of the i-th to-be-predicted vehicle,

$${v}_{i}^{0}$$

is the speed of the i-th to-be-predicted vehicle, and T′ is the prediction time period.

Further, the trajectory prediction system may use the steering angle

$${δ}_{i}^{t}$$

and acceleration a_{i,c} of the to-be-predicted vehicle as lateral and longitudinal control variables to determine the driving coordinates of the to-be-predicted vehicle at a next moment. That is, a state (position, speed, heading angle) of the to-be-predicted vehicle is updated, which may be determined specifically by the following Formulas 8 to 11.

$${x}_{i}^{t + 1} = {x}_{i}^{t} + {a}_{i , c} \cdot cos ( {θ}_{i}^{t} ) \cdot Δ t \qquad Formula 8$$

$${y}_{i}^{t + 1} = {y}_{i}^{t} + {a}_{i , c} \cdot sin ( {θ}_{i}^{t} ) \cdot Δ t \qquad Formula 9$$

$${θ}_{i}^{t + 1} = {θ}_{i}^{t} + \frac{{v}_{i}^{t} \cdot tan ( {δ}_{f} )}{L} \cdot Δ t \qquad Formula 10$$

$${v}_{i}^{t + 1} = {v}_{i}^{t} + {a}_{i , c} \cdot Δ t \qquad Formula 11$$

where,

$$( {x}_{i}^{t} , {y}_{i}^{t} )$$

represents the position information of the i-th to-be-predicted vehicle at moment t,

$${θ}_{i}^{t}$$

represents the heading angle of the i-th to-be-predicted vehicle at moment t,

$${v}_{i}^{t}$$

represents the speed of the i-th to-be-predicted vehicle at moment t, Δt is the time interval between adjacent time steps,

$$( {x}_{i}^{t + 1} , {y}_{i}^{t + 1} )$$

represents the position information of the i-th to-be-predicted vehicle at moment t+1, i.e., the driving coordinates of the to-be-predicted vehicle at the next moment,

$${θ}_{i}^{t + 1}$$

represents the heading angle of the i-th to-be-predicted vehicle at moment t+1, and

$${v}_{i}^{t + 1}$$

represents the speed of the i-th to-be-predicted vehicle at moment t+1.

After completing the state update of the to-be-predicted vehicle at the current moment t, the process of previewing forward along the reference path to obtain a preview point, and tracking the preview point through the steering angle and acceleration is continued repeatedly at moment t+1 to obtain the position coordinates of the to-be-predicted vehicle at the next moment, finally generating a motion-form trajectory where a rate of change of curvature at each point is controllable. As shown in FIG. 5, a black solid line represents the generated motion trajectory within the future prediction time period.

It should be understood that physical feasibility is crucial in vehicle trajectory prediction because it determines whether the prediction result can be practically applied in an autonomous driving system. If the predicted trajectory violates physical feasibility, even if its average displacement error is very small, it may cause the autonomous driving vehicle to encounter a trajectory that cannot be followed during actual driving, thereby causing a safety hazard. The trajectory prediction system provided by the embodiments of the present application comprehensively considers the motion state parameter and the motion feasibility constraint condition of the vehicle. The present application can obtain candidate road points that better conform to actual driving conditions of the vehicle by screening, thereby generating a more accurate driving trajectory.

At the same time, the embodiments of the present application also consider multiple factors such as the motion feasibility constraint condition (road condition, traffic rule), further improving reliability and practicality of trajectory prediction.

The above mainly introduces the solutions provided by the embodiments of the present application from the perspective of methods. In order to implement the above functions, an trajectory prediction apparatus or an electronic device includes corresponding hardware structures and/or software modules for executing the functions. Those skilled in the art should readily realize that, in combination with the units and algorithm steps of the examples described in the embodiments disclosed herein, the present application can be implemented in hardware or a combination of hardware and computer software. Whether a function is performed by hardware or computer software driving hardware depends on the specific application and design constraint condition of the technical solution. Skilled professionals may use a different method for each specific application to implement the described functions, but such implementation should not be considered beyond the scope of the present application.

The embodiments of the present application may exemplarily divide the trajectory prediction apparatus or the electronic device into functional modules according to the above methods. For example, the trajectory prediction apparatus or the electronic device may include various functional modules corresponding to various functions, or two or more functions may be integrated into one processing module. The above integrated modules may be implemented in the form of hardware or may be implemented in the form of software functional modules. It should be noted that the division of modules in the embodiments of the present application is schematic and is merely a logical function division, and other division methods may be used in actual implementation.

FIG. 7 is a block diagram of another trajectory prediction apparatus according to an exemplary embodiment. Referring to FIG. 7, the trajectory prediction apparatus includes: a processing unit 701 and an acquiring unit 702.

The acquiring unit 702 is configured to acquire a motion state parameter of a to-be-predicted vehicle and first candidate road points, where the first candidate road points are determined based on surrounding road information of the to-be-predicted vehicle. The processing unit 701 is configured to screen the first candidate road points based on the motion state parameter and a motion feasibility constraint condition of the to-be-predicted vehicle to obtain second candidate road points. The processing unit 701 is further configured to generate a motion trajectory of the to-be-predicted vehicle based on the second candidate road points.

In a possible implementation, the motion feasibility constraint condition is determined based on a road driving rule and/or configuration information of the to-be-predicted vehicle, and the motion feasibility constraint condition includes at least one of the following: a maximum acceleration constraint of the to-be-predicted vehicle, a maximum deceleration constraint of the to-be-predicted vehicle, a maximum steering constraint of the to-be-predicted vehicle, or a road speed limit constraint.

In a possible implementation, the processing unit 701 is specifically configured to: determine a first road segment at a preset distance in a motion direction of the to-be-predicted vehicle based on position information of the to-be-predicted vehicle and the surrounding road information; discretely sample the first road segment along a centerline of the first road segment to obtain third candidate road points; determine a first search area based on a current speed of the to-be-predicted vehicle, a heading angle of the to-be-predicted vehicle, and a road factor of the first road segment, where the road factor is determined based on a road segment type of the first road segment, a centerline orientation of the first search area is consistent with the heading angle, and a search range of the first search area is positively correlated with the current speed; and determine the first candidate road points from the third candidate road points based on the first search area.

In a possible implementation, the processing unit 701 is specifically configured to remove candidate points located within a near-end deceleration range and candidate points located outside a far-end acceleration range from the first candidate road points by screening to obtain the second candidate road points; where the near-end deceleration range is determined based on the current speed and the maximum deceleration constraint of the to-be-predicted vehicle, and the far-end acceleration range is determined based on the current speed, the maximum acceleration constraint, and the road speed limit constraint of the to-be-predicted vehicle.

In a possible implementation, the processing unit 701 is specifically configured to: determine a target road point from the second candidate road points; and generate the motion trajectory of the to-be-predicted vehicle based on the target road point; where the motion trajectory is a trajectory between a current position of the to-be-predicted vehicle and the target road point.

In a possible implementation, the processing unit 701 is specifically configured to input position information of the to-be-predicted vehicle, the motion state parameter of the to-be-predicted vehicle, and position information of the second candidate road points into a graph attention network model to obtain a target road point with a highest attention coefficient among the second candidate road points; where the attention coefficient is used to characterize a confidence degree of the to-be-predicted vehicle with respect to the candidate road point.

In a possible implementation, the processing unit 701 is specifically configured to: determine a reference path for the to-be-predicted vehicle based on the target road point, where the reference path is an expected path between a lane segment where the to-be-predicted vehicle is located and a lane segment where the target road point is located; determine a plurality of driving coordinates of the to-be-predicted vehicle based on the reference path and position information of the to-be-predicted vehicle; and generate the motion trajectory of the to-be-predicted vehicle according to the plurality of driving coordinates; where the motion trajectory is a trajectory between the current position of the to-be-predicted vehicle and the target road point.

In a possible implementation, the reference path includes a plurality of preview points, and the preview points are used to characterize expected coordinates on the reference path. The processing unit 701 is specifically configured to: for each preview point of the plurality of preview points, determine, based on the motion state parameter of the to-be-predicted vehicle, a steering angle required for the to-be-predicted vehicle to drive to the preview point; determine an acceleration of the to-be-predicted vehicle based on the position information of the to-be-predicted vehicle and the target road point; and determine driving coordinates of the to-be-predicted vehicle based on the acceleration and the steering angle, to obtain driving coordinates of the to-be-predicted vehicle corresponding to the plurality of preview points.

In a possible implementation, the processing unit 701 is specifically configured to: acquire a set of lane segments between a target lane segment and the lane segment where the to-be-predicted vehicle is located, where the target lane segment is the lane segment where the target road point is located; and equidistantly sample each lane segment in the set of lane segments along a lane centerline, to generate the reference path between the target lane segment and the lane segment where the to-be-predicted vehicle is located.

Regarding the apparatus in the above embodiments, the specific manner in which each module performs its operations has been described in detail in the method embodiments and will not be illustrated in detail here.

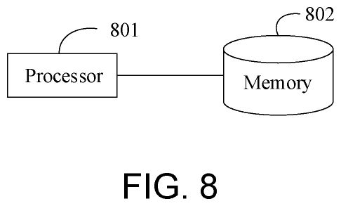

FIG. 8 is a block diagram of an electronic device according to an exemplary embodiment. As shown in FIG. 8, the electronic device includes, but is not limited to: a processor 801 and a memory 802.

The memory 802 is configured to store instructions executable by the processor 801. It can be understood that the processor 801 is configured to execute the instructions to implement the trajectory prediction method in the above embodiments.

It should be noted that those skilled in the art may understand that the structure of the electronic device shown in FIG. 8 does not constitute a limitation on the electronic device, and the electronic device may include more or fewer components than shown in FIG. 8, or combine certain components, or have a different arrangement of components.

The processor 801, which is a control center of the electronic device, connects various parts of the entire electronic device using various interfaces and lines, and performs various functions of the electronic device and processes data by running or executing software programs and/or modules stored in the memory 802 and calling data stored in the memory 802, thereby performing overall monitoring of the electronic device. The processor 801 may include one or more processing units. In an embodiment, the processor 801 may integrate an application processor and a modem processor, where the application processor mainly processes an operating system, a user interface, and application programs, etc., and the modem processor mainly processes wireless communication. It can be understood that the modem processor may also not be integrated into the processor 801.

The memory 802 may be configured to store software programs and various data. The memory 802 may mainly include a program storage area and a data storage area. The program storage area may store the operating system, the application programs required for at least one functional module (such as a determining unit, a processing unit, etc.), etc. In addition, the memory 802 may include a high-speed random access memory, and may also include a non-volatile memory, such as at least one magnetic disk storage device, a flash memory device, or other volatile solid-state storage devices.

In an exemplary embodiment, a computer-readable storage medium including instructions is further provided, such as the memory 802 including the instructions. The instructions may be executed by the processor 801 of the electronic device to implement the method in the above embodiments.

In an actual implementation, the functions of the processing unit 701 and the acquiring unit 702 in FIG. 7 may both be implemented by the processor 801 in FIG. 8 calling computer programs stored in the memory 802. The specific execution process may be found in the description of the method parts in the above embodiments, and will not be repeated here.

In an embodiment, the computer-readable storage medium may be a non-transitory computer-readable storage medium, such as a read-only memory (ROM), a random access memory (RAM), a Compact Disc ROM (CD-ROM), a magnetic tape, a floppy disk, an optical data storage device, etc.

In exemplary embodiments, an embodiment of the present application further provides a computer program product including one or more instructions, and the one or more instructions may be executed by the processor 801 of the electronic device to complete the method in the above embodiments.

It should be noted that when the instructions in the above computer-readable storage medium or the one or more instructions in the computer program product are executed by the processor of the electronic device, the various processes of the above method embodiments are implemented, and the same technical effects as the above methods are achieved, which are not repeated here to avoid repetition.

Through the description of the above implementations, those skilled in the art may clearly understand that for the convenience and brevity of description, the division of the above functional modules is used only as an example. In practical applications, the above functions may be assigned to different functional modules according to needs, i.e., an internal structure of the apparatus is divided into different functional modules to complete all or part of the functions described above.

In the several embodiments provided in the present application, it should be understood that the disclosed apparatuses and methods may be implemented in other ways. For example, the apparatus embodiments described above are merely illustrative. For example, the division of modules or units is only a logical function division, and in actual implementations, there may be other division manners. For example, multiple units or components may be combined or may be integrated into another apparatus, or some features may be ignored or not executed. On the other hand, the displayed or discussed mutual coupling, direct coupling, or communicative connection may be indirect coupling or communicative connection through some interfaces, apparatuses or units, and may be in electrical, mechanical or other forms.

Units described as separate components may or may not be physically separate, and the components displayed as units may be one physical unit or multiple physical units, that is, they may be located in one place or distributed over multiple different places. Some or all of the units may be selected according to actual needs to achieve the purpose of the solution of the embodiments.

In addition, various functional units in various embodiments of the present application may be integrated into one processing unit, or each unit may physically exist alone, or two or more units may be integrated into one unit. The above integrated unit may be implemented in the form of hardware or may be implemented in the form of a software functional unit.

The integrated unit may be stored in a readable storage medium, if the integrated unit is implemented in a form of a software functional unit and sold or used as an independent product. Based on such understanding, the technical solution of the embodiments of the present application in essence, or a part that contributes to the prior art, or all or part of the technical solution may be embodied in the form of a software product. The software product is stored in a storage medium, and includes a number of instructions which are used to cause a device (which may be a microcontroller, a chip, etc.) or a processor (processor) to perform all or part of the steps of the methods in the various embodiments of the present application. The aforementioned storage medium includes various media capable of storing program code, such as a U disk, a mobile hard disk, a ROM, a RAM, a magnetic disk, or an optical disk.

The above is only specific implementations of the present application, and the protection scope of the present application is not limited thereto. Any changes or substitutions within the technical scope disclosed in the present application should be covered within the protection scope of the present application. Therefore, the protection scope of the present application shall be subject to the protection scope of the claims.

What is claimed is:

1. A trajectory prediction method, applied to a target vehicle, wherein the method comprises:
acquiring a motion state parameter of a to-be-predicted vehicle and first candidate road points; wherein the first candidate road points are determined based on surrounding road information of the to-be-predicted vehicle;
screening the first candidate road points based on the motion state parameter and a motion feasibility constraint condition of the to-be-predicted vehicle to obtain second candidate road points; and
generating a motion trajectory of the to-be-predicted vehicle based on the second candidate road points.

2. The method according to claim 1, wherein the motion feasibility constraint condition is determined based on at least one of a road driving rule or configuration information of the to-be-predicted vehicle; wherein the motion feasibility constraint condition comprises at least one of the following:
a maximum acceleration constraint of the to-be-predicted vehicle;
a maximum deceleration constraint of the to-be-predicted vehicle;
a maximum steering constraint of the to-be-predicted vehicle; or
a road speed limit constraint.

3. The method according to claim 1, wherein the acquiring the first candidate road points comprises:
determining a first road segment at a preset distance in a motion direction of the to-be-predicted vehicle based on position information of the to-be-predicted vehicle and the surrounding road information;
discretely sampling the first road segment along a centerline of the first road segment to obtain third candidate road points;
determining a first search area based on a current speed of the to-be-predicted vehicle, a heading angle of the to-be-predicted vehicle, and a road factor of the first road segment; wherein the road factor is determined based on a road segment type of the first road segment; wherein a centerline orientation of the first search area is consistent with the heading angle; wherein a search range of the first search area is positively correlated with the current speed; and
determining the first candidate road points from the third candidate road points based on the first search area.

4. The method according to claim 2, wherein the screening the first candidate road points based on the motion state parameter and the motion feasibility constraint condition of the to-be-predicted vehicle to obtain the second candidate road points comprises:
removing candidate points located within a near-end deceleration range and candidate points located outside a far-end acceleration range from the first candidate road points by screening to obtain the second candidate road points;
wherein the near-end deceleration range is determined based on the current speed and the maximum deceleration constraint of the to-be-predicted vehicle; wherein the far-end acceleration range is determined based on the current speed, the maximum acceleration constraint, and the road speed limit constraint of the to-be-predicted vehicle.

5. The method according to claim 1, wherein the generating the motion trajectory of the to-be-predicted vehicle based on the second candidate road points comprises:
determining a target road point from the second candidate road points; and
generating the motion trajectory of the to-be-predicted vehicle based on the target road point; wherein the motion trajectory is a trajectory between a current position of the to-be-predicted vehicle and the target road point.

6. The method according to claim 5, wherein the determining the target road point from the second candidate road points comprises:
inputting position information of the to-be-predicted vehicle, the motion state parameter of the to-be-predicted vehicle, and position information of the second candidate road points into a graph attention network model to obtain a target road point with a highest attention coefficient among the second candidate road points; wherein the attention coefficient is used to characterize a confidence degree of the to-be-predicted vehicle with respect to a candidate road point.

7. The method according to claim 5, wherein the generating the motion trajectory of the to-be-predicted vehicle based on the target road point comprises:
determining a reference path for the to-be-predicted vehicle based on the target road point; wherein the reference path is an expected path between a lane segment where the to-be-predicted vehicle is located and a lane segment where the target road point is located;
determining a plurality of driving coordinates of the to-be-predicted vehicle based on the reference path and position information of the to-be-predicted vehicle; and
generating the motion trajectory of the to-be-predicted vehicle according to the plurality of driving coordinates; wherein the motion trajectory is a trajectory between the current position of the to-be-predicted vehicle and the target road point.

8. The method according to claim 7, wherein the reference path comprises a plurality of preview points; wherein the preview points are used to characterize expected coordinates on the reference path;
wherein the determining the plurality of driving coordinates of the to-be-predicted vehicle based on the reference path and the position information of the to-be-predicted vehicle comprises:
for each preview point of the plurality of preview points, determining, based on the motion state parameter of the to-be-predicted vehicle, a steering angle required for the to-be-predicted vehicle to drive to the preview point;
determining an acceleration of the to-be-predicted vehicle based on the position information of the to-be-predicted vehicle and the target road point; and
determining driving coordinates of the to-be-predicted vehicle based on the acceleration and the steering angle, to obtain driving coordinates of the to-be-predicted vehicle corresponding to the plurality of preview points.

9. The method according to claim 7, wherein the determining the reference path for the to-be-predicted vehicle based on the target road point comprises:
acquiring a set of lane segments between a target lane segment and the lane segment where the to-be-predicted vehicle is located; wherein the target lane segment is the lane segment where the target road point is located; and
equidistantly sampling each lane segment in the set of lane segments along a lane centerline, to generate the reference path between the target lane segment and the lane segment where the to-be-predicted vehicle is located.

10. A trajectory prediction apparatus, wherein the apparatus comprises: a processor, and a memory configured to store instructions executable by the processor; wherein the processor is configured to execute the instructions to:
acquire a motion state parameter of a to-be-predicted vehicle and first candidate road points; wherein the first candidate road points are determined based on surrounding road information of the to-be-predicted vehicle;
screen the first candidate road points based on the motion state parameter and a motion feasibility constraint condition of the to-be-predicted vehicle to obtain second candidate road points; and
generate a motion trajectory of the to-be-predicted vehicle based on the second candidate road points.

11. The apparatus according to claim 10, wherein the motion feasibility constraint condition is determined based on at least one of a road driving rule or configuration information of the to-be-predicted vehicle; wherein the motion feasibility constraint condition comprises at least one of the following:
a maximum acceleration constraint of the to-be-predicted vehicle;
a maximum deceleration constraint of the to-be-predicted vehicle;
a maximum steering constraint of the to-be-predicted vehicle; or
a road speed limit constraint.

12. The apparatus according to claim 10, wherein when acquiring the first candidate road points, the processor is specifically configured to:
determine a first road segment at a preset distance in a motion direction of the to-be-predicted vehicle based on position information of the to-be-predicted vehicle and the surrounding road information;
discretely sample the first road segment along a centerline of the first road segment to obtain third candidate road points;
determine a first search area based on a current speed of the to-be-predicted vehicle, a heading angle of the to-be-predicted vehicle, and a road factor of the first road segment; wherein the road factor is determined based on a road segment type of the first road segment; wherein a centerline orientation of the first search area is consistent with the heading angle; wherein a search range of the first search area is positively correlated with the current speed; and
determine the first candidate road points from the third candidate road points based on the first search area.

13. The apparatus according to claim 11, wherein when screening the first candidate road points based on the motion state parameter and the motion feasibility constraint condition of the to-be-predicted vehicle to obtain the second candidate road points, the processor is specifically configured to:
remove candidate points located within a near-end deceleration range and candidate points located outside a far-end acceleration range from the first candidate road points by screening to obtain the second candidate road points;
wherein the near-end deceleration range is determined based on the current speed and the maximum deceleration constraint of the to-be-predicted vehicle; wherein the far-end acceleration range is determined based on the current speed, the maximum acceleration constraint, and the road speed limit constraint of the to-be-predicted vehicle.

14. The apparatus according to claim 10, wherein when generating the motion trajectory of the to-be-predicted vehicle based on the second candidate road points, the processor is specifically configured to:
determine a target road point from the second candidate road points; and
generate the motion trajectory of the to-be-predicted vehicle based on the target road point; wherein the motion trajectory is a trajectory between a current position of the to-be-predicted vehicle and the target road point.

15. The apparatus according to claim 14, wherein when determining the target road point from the second candidate road points, the processor is specifically configured to:
input position information of the to-be-predicted vehicle, the motion state parameter of the to-be-predicted vehicle, and position information of the second candidate road points into a graph attention network model to obtain a target road point with a highest attention coefficient among the second candidate road points; wherein the attention coefficient is used to characterize a confidence degree of the to-be-predicted vehicle with respect to a candidate road point.

16. The apparatus according to claim 14, wherein when generating the motion trajectory of the to-be-predicted vehicle based on the target road point, the processor is specifically configured to:
determine a reference path for the to-be-predicted vehicle based on the target road point; wherein the reference path is an expected path between a lane segment where the to-be-predicted vehicle is located and a lane segment where the target road point is located;
determine a plurality of driving coordinates of the to-be-predicted vehicle based on the reference path and position information of the to-be-predicted vehicle; and
generate the motion trajectory of the to-be-predicted vehicle according to the plurality of driving coordinates; wherein the motion trajectory is a trajectory between the current position of the to-be-predicted vehicle and the target road point.

17. The apparatus according to claim 16, wherein the reference path comprises a plurality of preview points; wherein the preview points are used to characterize expected coordinates on the reference path;
wherein when determining the plurality of driving coordinates of the to-be-predicted vehicle based on the reference path and the position information of the to-be-predicted vehicle, the processor is specifically configured to:
for each preview point of the plurality of preview points, determine, based on the motion state parameter of the to-be-predicted vehicle, a steering angle required for the to-be-predicted vehicle to drive to the preview point;
determine an acceleration of the to-be-predicted vehicle based on the position information of the to-be-predicted vehicle and the target road point; and
determine driving coordinates of the to-be-predicted vehicle based on the acceleration and the steering angle, to obtain driving coordinates of the to-be-predicted vehicle corresponding to the plurality of preview points.

18. The apparatus according to claim 16, wherein when determining the reference path for the to-be-predicted vehicle based on the target road point, the processor is specifically configured to:
acquire a set of lane segments between a target lane segment and the lane segment where the to-be-predicted vehicle is located; wherein the target lane segment is the lane segment where the target road point is located; and
equidistantly sample each lane segment in the set of lane segments along a lane centerline, to generate the reference path between the target lane segment and the lane segment where the to-be-predicted vehicle is located.

19. A vehicle, comprising the apparatus according to claim 10.

20. A non-transitory computer-readable storage medium, wherein when computer executable instructions stored in the non-transitory computer-readable storage medium are executed by a processor of an electronic device, the electronic device is enabled to perform the following operations:
acquiring a motion state parameter of a to-be-predicted vehicle and first candidate road points; wherein the first candidate road points are determined based on surrounding road information of the to-be-predicted vehicle;
screening the first candidate road points based on the motion state parameter and a motion feasibility constraint condition of the to-be-predicted vehicle to obtain second candidate road points; and
generating a motion trajectory of the to-be-predicted vehicle based on the second candidate road points.
